(19) United States
(12) Patent Application Publication
(10) Pub. No.: US 2014/0356529 A1
(43) Pub. Date: Dec. 4, 2014

(54) SYSTEMS AND METHODS FOR REINFORCING A PIPE USING FIBER BUNDLES AND FIBER BUNDLE RIBBON

(71) Applicant: Fyfe Co. LLC, San Diego, CA (US)

(72) Inventors: Ryan Goodell, San Diego, CA (US); Sean Wisotzkey, San Diego, CA (US); Heath Carr, San Diego, CA (US); Edward Fyfe, San Diego, CA (US)

(21) Appl. No.: 14/460,955

(22) Filed: Aug. 15, 2014

Related U.S. Application Data
(63) Continuation of application No. PCT/US2013/026308, filed on Feb. 15, 2013.
(60) Provisional application No. 61/600,433, filed on Feb. 17, 2012.

(51) Int. Cl. B05D 1/02; B25J 11/00; B05C 7/08; B25J 5/00

(52) U.S. Cl. CPC B05D 1/02; B25J 5/007; B25J 11/0075; B05C 7/08; Y10S 901/43
USPC 427/236; 180/21; 118/318; 901/43

(57) ABSTRACT

Systems and methods for reinforcing a pipe. A robot is adapted for rotating in a pipe to apply resin and/or fiber to an inner surface of a pipe in a generally helical pattern. Application of resin and/or fiber to the pipe may be actively adjusted to achieve desired application. A rate at which the robot moves along the pipe per revolution of the robot can be may be adjustable. A rate at which fiber is advanced toward the inner surface of the pipe may be adjustable for application of the fiber to the inner surface of the pipe in a generally non-tensioned state.

### CROSS-REFERENCE TO RELATED APPLICATIONS

This application is a continuation of PCT/US2013/026308, filed Feb. 15, 2013, and claims priority to 61/600,433, filed, Feb. 17, 2012, both of which are hereby incorporated by reference in their entireties.

### FIELD OF THE INVENTION

The present disclosure generally relates to pipe rehabilitation. In particular, the present disclosure relates to systems and methods for reinforcing a pipe using fiber bundles which may be in the form of a fiber bundle ribbon.

### BACKGROUND OF THE INVENTION

According to the American Society of Civil Engineers (ASCE), the United States national drinking water and waste water infrastructure has a rating of D−. As a result, over 240 thousand water main breaks occur each year, and an estimated $255 billion is needed over the next five years to adequately address the problem. The cost of failure is not only due to the repair of the pipe itself, but also from the estimated 25 million gallons of water wasted per break. This endeavor is focusing on the 3.5 million linear feet of large diameter (61 cm (24 inches) and larger) steel pipe and pre-stressed concrete cylinder pipe (PCCP) estimated to be failing prematurely. These failures arise from a variety of factors including age, construction quality, soil impacts, earthquakes, installation error, and poor overall design.

There are a few widely used methods to repair failed pipelines, many of which involve some form of excavation of or around the failed sections. The most prevalent options include post-tension repair, slip lining, replacement, and cured in place liner installation (CIP). Post tension repair is where steel cables are wrapped and tensioned onto the outside of a pipe for reinforcement. One major drawback of this system is that it does not seal the pipe. The pipe must also be exposed (excavated) in order to gain access around the circumference for the cables. Slip lining is a practice where smaller pipe sections are inserted inside failed sections and bonded to the existing pipe. Excavation of at least one section is needed in order to get the slip line inside of the failed section. Another problem is that a flow restriction is created in the pipe due to the diameter reduction of the liner. Replacement of a bad pipe section involves excavation around the pipe, removal, and then installing a new section. Any of the above approaches, due to the excavation needed are either too intrusive, or not possible in the case of a water pipe underneath a building. A much better approach is to repair the section from inside the pipe. Cured in place liners do a great job of sealing a failed pipe from the inside. However, they cannot provide a full structural repair. A good form of internal pipe repair comes in the form of fiber reinforced polymers or composites (FRP) due to its lack of excavation, complete pipe sealing, time, and structural strengthening abilities.

FRP is used primarily in aerospace and other high-end applications due to its high strength and low weight. It was not widely accepted as a viable solution to pipeline repair until 1997, which makes it a fairly new technology. FRP is corrosion resistant, has a high strength and modulus which enable complete structural repair, and offers complete material flexibility in both the design and application. Carbon fiber is able to be oriented in such a way that strength characteristics can be custom suited to the application. The repair can also be easily adapted to handle more load simply by applying more carbon to the wall of the pipe. The typical installation of carbon fiber involves using some sort of a saturator to impregnate the carbon fiber with resin and then hand applying the saturated carbon fiber onto the inner wall of a pipe. Because the process is a wet layup, the carbon fiber is able to conform completely to the inside of the pipe, ensuring a complete bond to the substrate. An added benefit to this process is that most of the time, the head losses through that section are reduced due to the smooth surface of the FRP.

### SUMMARY

In a first aspect, the present invention includes a robot adapted for rotation in a pipe having a longitudinal axis and an inner surface including a circumference. The robot includes a frame having an axis about which the frame is adapted to rotate in use. The axis of rotation extends in generally the same direction as the longitudinal axis of the pipe when the robot is positioned in the pipe. The robot includes a plurality of wheels connected to the frame at different radial positions with respect to the axis of rotation for engaging the inner surface of the pipe at different circumferential positions. The robot includes a drive mechanism adapted for driving at least one of the wheels for causing the wheel to roll along the inner surface of the pipe and the frame to rotate in the pipe about the longitudinal axis of the pipe. The wheels are adapted for rolling along the inner surface of the pipe in a generally helical path for moving the frame along the longitudinal axis of the pipe as the frame rotates in the pipe.

In another aspect, the present invention includes a method of applying material to an inner surface of a pipe for reinforcing the pipe. The method includes driving a wheel against the inner surface of the pipe to cause a frame to which the wheel is connected to rotate within the pipe and move along a longitudinal axis of the pipe. As the frame rotates within the pipe, material from a web of material is advanced toward the inner surface of the pipe and is applied to the inner surface of the pipe in a generally helical pattern.

In yet another aspect, the present invention includes a method of applying fiber to a structure for reinforcing the structure. The method includes driving fiber toward a press member, moving the press member with respect to the structure to apply the fiber to the structure by pressing it on the structure, and automatically adjusting a rate at which the fiber is driven toward the press member such that the fiber pressed by the press member against the structure is generally non-tensioned.

Other objects and features will be in part apparent and in part pointed out hereinafter.

### BRIEF DESCRIPTION OF THE DRAWINGS

FIG. 1 is a perspective of a robot of the present invention;

FIG. 2 is an enlarged view of an applicator assembly of the robot of FIG. 1;

FIG. 3 is a perspective of a segment of a fiber bundle ribbon which may be installed by the robot;

FIG. 4 is a perspective of fiber bundles of the ribbon in un-stabilized form; and

FIG. 5 is a perspective of a layup of the fiber bundle ribbon having about a 50% overlap.

Corresponding reference characters indicate corresponding parts throughout the drawings.

### DETAILED DESCRIPTION

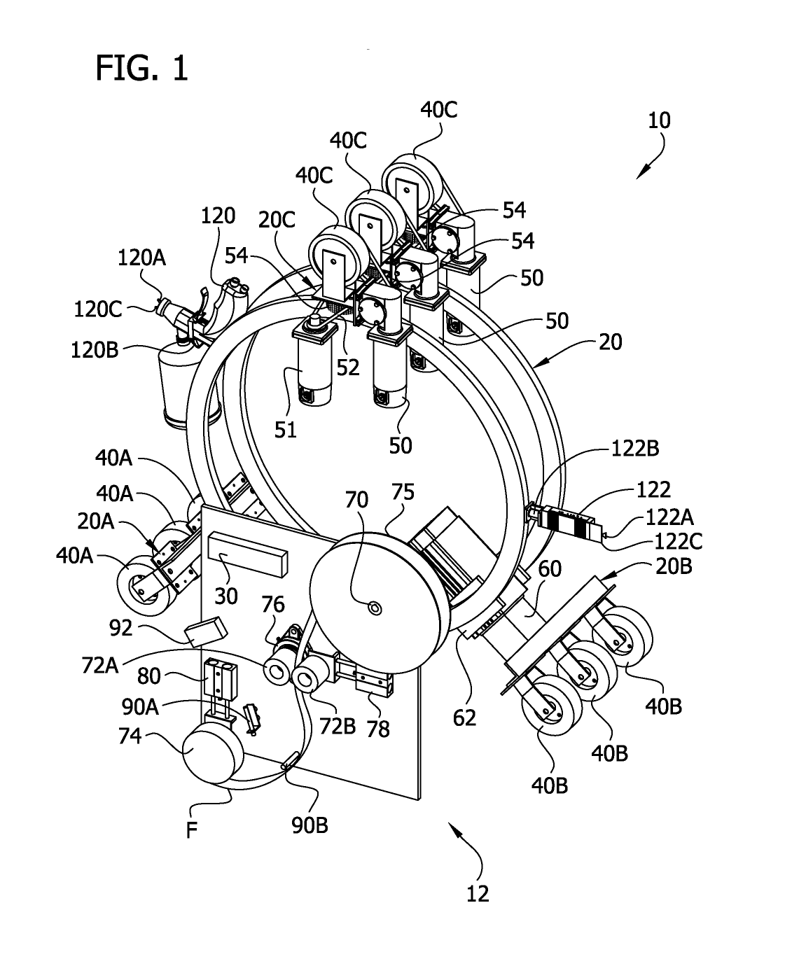

A reinforcement system of the present invention is adapted for reinforcing a pipe by applying material such as fiber reinforcement (e.g., fiber bundle ribbon) on an interior surface of the pipe. As discussed in further detail below, various types of fiber reinforcement (broadly “material”) may be used. In general, the reinforcement system may include a supply of fiber reinforcement, a saturator for saturating the fiber reinforcement with resin, and an installation robot or robot (e.g., see FIG. 1) for positioning the fiber reinforcement on the inside surface of the pipe. In a general method, the internal surface of the pipe may be prepared by cleaning and/or applying an intermediate layer(s) or coating(s) to the surface of the pipe. The resin impregnated or saturated fiber reinforcement is then applied. Upon cure of the resin, the fiber reinforcement provides the pipe with increased strength. The reinforcement system may be used for reinforcing structures other than pipes (e.g., beams, columns, and other structures) without departing from the scope of the present invention. Examples of reinforcement systems are disclosed in U.S. patent application Ser. No. 12/709,388, Pub. No. 2010/0212803, which is hereby incorporated by reference in its entirety.

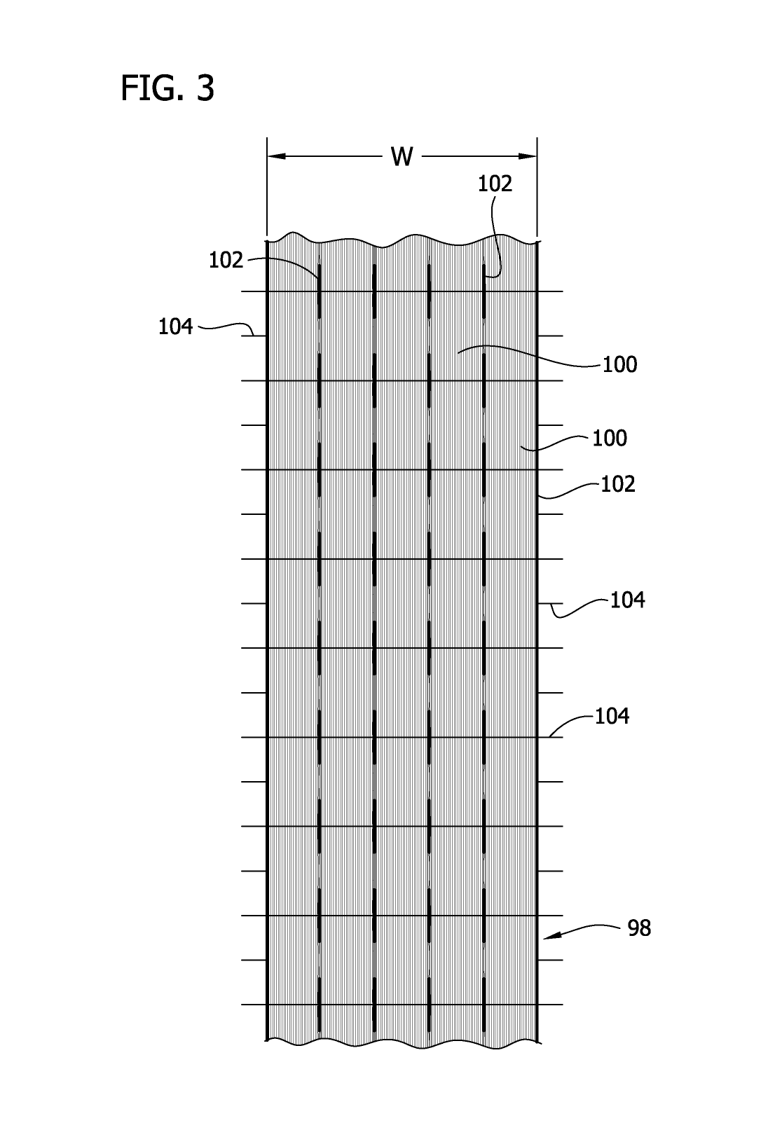

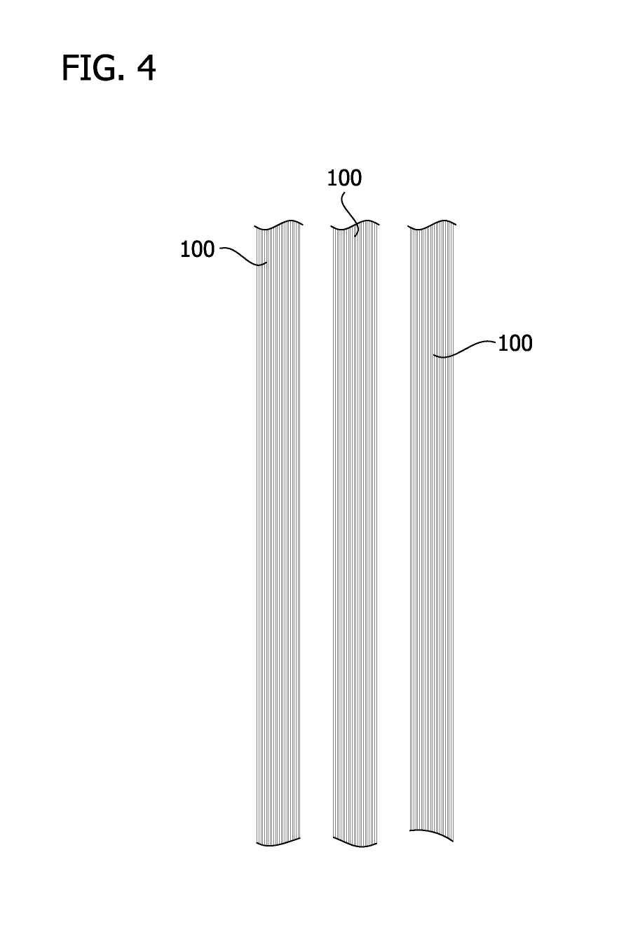

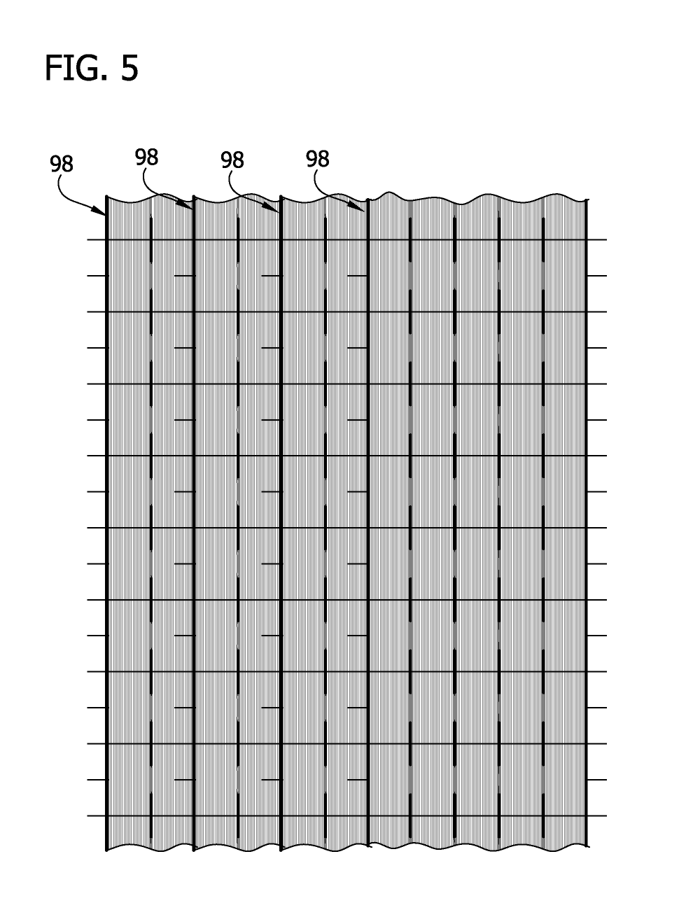

As shown in FIG. 1, an embodiment of an installation robot of the present invention is designated generally by the reference number 10. The installation robot 10 is adapted for navigating a pipe and includes an applicator assembly 12 adapted for applying fiber reinforcement to the interior of the pipe. As described in further detail below, the installation robot 10 is configured to rotate about an axis of rotation which in use extends in the same general direction of the longitudinal axis of the pipe. Rotation of the robot 10 causes it to move along the longitudinal axis of the pipe. Accordingly, the applicator assembly 12 can be selectively moved around the inner circumference of the pipe in a generally helical path. The applicator assembly 12 applies material (e.g., fiber reinforcement) around an entire inner circumferential region of the pipe in one or more layers which may be overlapped. In the pictured embodiment, the fiber reinforcement is provided in the form of a ribbon (see FIG. 3) including bundles of fiber (see FIG. 4) which may be overlapped in application (e.g., see FIG. 5). The ribbon and/or the bundles (i.e., tows or rovings) of fiber may be referred to as a web of material. As will become apparent, material of the web of material (whether in stabilized form such as the ribbon or unstabilized form such as the loose bundles) may be applied by the robot 10 to a surface. As described in further detail below, various forms of fiber reinforcement may be used.

In general, the installation robot 10 includes a frame or cart 20 having three carriages 20A, 20B, 20C, the applicator assembly 12, and a controller 30. The controller 30 may be operatively connected to various components of the installation robot 10 for controlling operation thereof, as described in further detail below. All three of the carriages 20A, 20B, 20C include wheels which engage the interior surface of the pipe. Two of the carriages 20A, 20B include wheels in the form of freely pivotable casters 40A, 40B. The third carriage 20C includes drive wheels 40C powered by respective motors 50. In use, the wheels 40A, 40B, 40C roll along the inner surface of the pipe in a generally helical path for moving the frame along the longitudinal axis of the pipe as the frame rotates in the pipe. The axis of rotation of the robot 10 is generally located at a central position of the robot radially inward from the wheels 40A, 40B, 40C of each carriage 20A, 20B, 20C. The multiple wheels of each carriage 20A, 20B, 20C and the spacing between the wheels of each carriage stabilize the robot 10 and enable the robot to effectively cross joints or other discontinuities in the pipe. For example, joints usually need to be chipped out (excavated) so the FRP can be anchored to the pipe at the ends of the repair section. The spaced wheels of each carriage 20A, 20B, 20C permits the robot to travel across these joints because the space between the wheels spans the joints when entering and exiting the pipe to be reinforced.

The drive wheels 40C are selectively positionable at various pitches or angles with respect to the longitudinal axis of the pipe or with respect to an axis extending perpendicular to the longitudinal axis to adjust the rate at which the installation robot 10 advances along the pipe as it rotates. This enables application of fiber by the applicator assembly 12 in different helical patterns in the pipe (e.g., no overlap, minimal overlap, or substantial overlap of fiber in successive revolutions of the robot). The orientation of the drive wheels 40C may be automatically controlled, as described in further detail below. In the illustrated embodiment, the orientation of the drive wheels 40C may be changed by activating an adjustment mechanism including a motor 51 and drive chain 52 engaging gears 54 at the base of the drive wheels about which the drive wheels are rotatable. Other drive mechanisms and other ways of changing the orientation of the drive wheels 40C or other wheels 40A, 40B of the robot 10 may be used without departing from the scope of the present invention.

Macro and/or micro adjustment capabilities may be incorporated into the robot 10 to provide sufficient engagement of the carriages 20A, 20B, 20C with the inner surface of the pipe. Pipes in need of fiber reinforcement come in all shapes and sizes. For example, some pipes range in nominal diameter from 122 cm to 183 cm (48 inches to 72 inches). Not only do pipes vary in nominal size, they can also be out of round or oblong. The frame 20 or one or more of the carriages 20A, 20B, 20C may be adjustable to permit the installation robot 10 to be adjusted in size on a macro scale for accommodating different nominal diameter pipes and/or on a micro scale for accommodating discontinuities within a certain pipe. Structure supporting the wheels 40A, 40B, 40C may include a mechanism which enables them to extend away from and/or retract toward the frame 20. For a macro adjustment, the frame 20 may include lengthening sections built into it that adjust for larger and smaller nominal pipe diameters. As an example, the installation robot 10 is illustrated as including larger scale adjustability in the form of a shaft 60 supporting the carriage 20B which is selectively positionable with respect to the frame 20 of the installation robot. The shaft 60 can be selectively secured to the frame 20 via clamp 62 at different positions along its length to provide significant size adjustment to the installation robot. The shaft 60 permits the wheels 40B of the carriage 20B to be moved radially away from or toward the frame 20. The robot 10 may also include devices adapted to provide micro adjustment. This ensures contact of the drive wheels 40C against the interior of the pipe, and accommodates for protrusions, indentations, and other discontinuities in the pipe wall. For example, the robot 10 may include pneumatic pistons which may be manually or automatically adjusted (e.g., within a range of about 15 cm (6 inches) to account for discontinuities in the pipe.

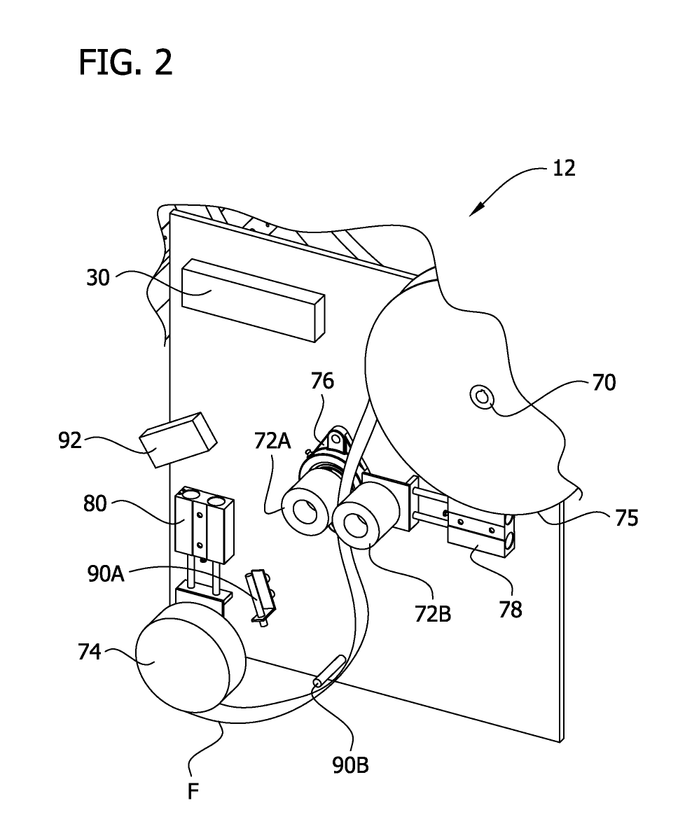

Referring to FIG. 2, the applicator assembly 12 generally includes a spool mount 70 (broadly “fiber supply holder”), drive rollers 72A, 72B (broadly “drive mechansim”), and a press wheel 74 (broadly “press member”). A spool 75 of fiber F is shown on the spool mount 70. A motor 76 drives the drive roller 72A. A linear actuator 78 moves the drive roller 72B toward and away from the drive roller 72A so the drive roller 72B presses the reinforcing fiber against the drive roller 72A. A linear actuator 80 moves the press wheel toward and away from the application surface (i.e., inner surface of a pipe). The arrangement is such that fiber F is fed from a drive mechanism (e.g., the drive rollers 72A, 72B) under a press member (e.g., the press roller 74) that presses the fiber reinforcement onto the inner surface of the pipe and also adapts for eccentricity in the pipe (e.g., via actuator 80). The arrangement advantageously avoids twisting of the fiber F from the spool 75 to the pipe wall.

The robot 10 may include a control system for controlling various functions of the robot. For example, the control system may include the controller 10 and various sensors such as one or more fiber tension or slack sensors 90A, 90B and/or fiber position sensors 92. The controller 10 is operatively connected to these sensors 90A, 90B, 92 and to other components of the robot 10 (e.g., the motors 50, 51 of the drive wheels 40C, the drive rollers 72A, 72B, and/or the linear actuators 78, 80). The controller 10 may include instructions for operating these components in various ways.

In a first aspect of the control system, it may adjust advancement of the fiber F toward the press wheel 74 to accomplish a desired tension of fiber pressed onto the inner pipe surface. In general, it may be desirable that the fiber be applied to the pipe wall with about zero tension (broadly “in a generally non-tensioned state”). If tension exists in the fiber F as it is applied, it may pull the previously laid or overlapped fiber layer off the inner surface of the pipe. Conversely, if too much fiber F is delivered to the press wheel 74, folds and wrinkles may develop. The control system may use a tension sensor in the form of a laser sensor 90A. The laser sensor 90A is positioned between the drive rollers 72A, 72B and the press wheel 74 and measure distance of the fiber F from the laser. A desired distance of the fiber from the laser 90A may be determined empirically as being associated with a desired fiber tension. The controller 10 may include instructions for increasing or decreasing advancement of the fiber F by the drive rollers 72A, 72B to achieve the distance as a function of sensed deviations indicated by signals provided to the controller from the laser sensor 90A. Alternatively, or in addition, the control system may use a tension sensor in the form of a pressure gauge 90B. In the illustrated embodiment, a pressure arm 90B (e.g., a “dance arm”) is positioned between the drive rollers 72A, 72B and the press wheel 74 for determining a tension of the fiber based on pressure applied by the fiber to the pressure arm. The pressure arm 90B moves along a range of movement in response to pressure applied to the pressure arm by the fiber. The controller 10 receives signals from the pressure arm based on the pressure applied by the fiber. The controller 10 may include instructions for increasing or decreasing advancement of the fiber by the drive rollers a72A, 72B as a function of signals received from the pressure arm 90B. Accordingly, the control system may adjust the amount of fiber delivered to the press wheel 74 to achieve a minimal tension layup, regardless of changes in circumferential speed of the robot 10.

In another aspect of the control system, it may control the helical pattern in which the fiber F is applied to the inner surface of the pipe. The robot 10 may perform layup in an almost pure hoop wrap (e.g., less than one degree offset) or with various degrees of offset. Because several factors contribute to the hoop strength required, the robot 10 may include a control system to vary thickness (i.e., overlap) of applied fiber reinforcement. The thickness needed for the repair will be pre-determined by the necessary load characteristics of the pipe. More pitch on the wheels 40C will cause the robot 10 to progress further down the pipe per revolution and ultimately lower the overlap of the fibers. This would lead to a thinner overall repair. The opposite would be true as the pitch gets closer to a 90 degree rotation, causing a thicker repair. For example, a 50% overlap, such as shown in FIG. 5, would result in 2 overall layers, or double the thickness of a single fiber ribbon applied to the pipe wall. A 60% overlap would result in three overall layers, or triple the thickness of a single fiber ribbon applied to the pipe wall. Moreover, a 75% overlap would result in four overall layers, or quadruple the thickness of a single fiber ribbon applied to the pipe wall. Other overlaps or no overlap may be used as desired without departing from the scope of the present invention. As described below, various offsets or pitches may be used and may be automatically controlled for applying the fiber reinforcement at different rates along the pipe.

The control system may use a fiber position sensor 92 such as a camera or laser to monitor placement of fiber by the applicator assembly 12. For example without limitation, the sensor 92 may sense a position of the fiber immediately trailing the press wheel with respect to the fiber applied in the previous revolution of the robot. The controller 10 may monitor the fiber position to ensure the desired generally helical pattern is achieved (e.g. a certain amount of overlap). The control system may automatically adjust the pitch of the drive wheels 40C to provide consistent application of the fiber reinforcement according to desired overlap or application pitch. The controller 10 may adjust the orientation of the drive wheels 40C as a function of the sensed position of the fiber based on signals from the fiber sensor 92.

A robotic approach also has the ability to do onboard quality assurance as the material is being applied. Traditionally, an inspector must ensure quality after the wrapping is complete. The major defect that arises is a de-lamination of the fiber from the pipe wall. If voids are determined to exist, the spot must be injected with epoxy to ensure a failure will not occur when the pipe is pressurized. The fiber position sensor 92 (or other fiber position sensors) may be used to detect whether a de-lamination has happened and so an operator may be alerted. For example, a position sensor may be positioned on the robot to monitor fiber applied to the inner surface of the pipe in previous revolutions of the robot to determine whether it has de-laminated.

Automation of application of fiber reinforcement according to the present invention provides several advantages. The hand applied, wet layup of FRP works well in strengthening and repairing water pipes. However, it is very labor intensive, requires a trained crew, and works only in large diameter pipes. By automating the process with the robot 10, many of these concerns can be reduced. The robot 10 has the ability to work faster than a manual operator, with increased precision, for a longer working time and in smaller diameter pipes. Onboard sensors such as the sensors 90A, 90B, 92 can provide feedback to control systems either for process control or for post application quality assurance. The robot 10 also has the ability to lay down un-stabilized fiber roving, something that a human simply cannot do by hand. Theoretically, a robot-wrapped pipe should be stronger than a hand wrapped pipe, when the same amount of material is applied, due to the improved accuracy of placement of the bundles, either in stabilized or un-stabilized form by the robot. A robot as referred to herein may be totally automated, only partially automated, or totally under human control.

As used herein, fiber or FRP may include various types of fibers, whether stabilized or un-stabilized, including carbon (e.g., carbon fiber reinforced polymer (CFRP)) and/or other fibers such as nylon, glass, graphite, polyaramid, or other fibers having suitable material characteristics. FRP is corrosion resistant, has a high strength and modulus which enable complete structural repair, and offers complete material flexibility in both the design and application. Fibers can be oriented in such a way that strength characteristics can be custom suited to the application. The repair can also be easily adapted to handle more load simply by applying more fibers to the wall of the pipe.

Traditionally, stitched or stabilized fabrics are used for internal FRP pipe repairs. Stitched fabrics consist of large numbers of carbon fiber bundles (also called rovings or tows), each consisting of up to 50 thousand individual fibers, stitched or woven together to form a single sheet. If the bundles are woven they form a bidirectional or cross-ply fabric. However, most of the time, a unidirectional, or stitched fabric is used due its high strength in one direction (i.e., fiber reinforcement extending in one direction only). A difficulty associated with using a stitched fabric is the stitching itself The stitching causes waves in the carbon fibers as well as voids where the stitches are. This contributes to an overall loss in properties in comparison to the carbon bundles themselves.

According to the present invention, a stabilized matrix or web of fiber reinforcement, such as the ribbon 98 illustrated in FIG. 3, may be used which includes individual bundles of fiber reinforcement stabilized together. For example, the ribbon 98 may have a width W of about 5 cm (about 2 inches). The ribbon is formed using loose bundles of fibers 100 such as those shown in FIG. 4. The fiber bundles 100 are stabilized by positioning them between longitudinal stabilizing threads 102 and weaving them between transverse stabilizing threads 104 (i.e., above then below consecutive transverse threads). The spacing between adjacent transverse threads 104 may be between about 0.6 cm to about 3.8 cm (about 0.25 inches to about 1.5 inches). For example, the transverse threads 104 may be spaced from one another by at least about 1.3 cm (about 0.5 inches) or at least about 1.6 cm (about ⅝ inches). The transverse threads 104 are beneficial to stabilize the fiber bundles, but there are diminishing returns in that the more transverse threads there are the more adversely they affect the strength characteristics of the fiber bundles. The longitudinal threads 102 extend generally parallel with and between respective fiber bundles 100. A hot melt applied to the transverse threads 104 secures them to the fiber bundles 100 and to the longitudinal threads 102. Two longitudinal threads 102 are provided on each side edge of the ribbon 98 and are weaved between the transverse threads 104 in alternating fashion. Compared to stitched fabrics, the ribbon 98 has increased strength due to lack of stitching. The ribbon 98 enables a more cost effective overall repair. Fiber bundles such as the bundles 100 are difficult to lay straight by hand, due to their affinity when saturated to stick to each other and to themselves. The stabilization of the bundles 100 by incorporating them in the unidirectional ribbon 98 facilitates handling and application of the fiber bundles. However, as discussed herein, other forms of fiber reinforcement such as a web of un-stabilized bundles 100 may be used without departing from the scope of the present invention.

A saturator (not shown) may be provided on the robot 10 or be provided as a separate piece of equipment for introducing resin in the fiber reinforcement. The resin bonds the fibers together, seals the composite, and keeps the fibers attached to the walls of the pipe. An optimum fiber/resin ratio is desirably results in increased overall strength of the repair, improved ability of the fibers to stick to the walls, and less material usage/cost. A saturator for use with the robot 10 may include an impregnation bath with a controllable doctor blade for resin metering, and a spool up section to create carbon fiber spools 75 or cartridges for the robot to use. Separation of the saturator and the robot 10 enables the two pieces of equipment to run independently of each other. However, the saturator may be provided in-line with the robot 10 and/or be provided on the robot. Consistent windup throughout the entire spool 75 is desirable. Otherwise, resin content can change as inner layers get crushed by outer layers during the windup process. Also, if the FRP is un-stabilized, the bundles may have a tendency to wrinkle as they are spooled.

The robot 10 may include additional devices for use in preparing the pipe for application of fiber reinforcement F. The pipe surface, prior to FRP installation, may be blasted by high pressure water to prepare an adequate bonding surface. Before the fiber is applied, though, a primer resin and a thickened resin may be applied to the blasted pipe wall. The primer resin is a fast set epoxy that bonds the thickened epoxy to the concrete substrate. The thickened epoxy is used to both render the surface smooth again as well give the carbon fiber a tacky surface to attach to. The surface might need to be re-rendered smooth because of the protrusions and exclusions left in the surface by the water blasting operation. Traditionally, both of these processes are done by hand, with the primer resin being rolled onto the surface, and the thickened epoxy being applied with a trowel.

As shown in FIG. 1, the robot 10 may include one or more resin or epoxy applicators 120, 122 for automating both the primer and thickened epoxy application operations. The applicator 120 is a spray device having a spray head 120A for applying primer, and the applicator 122 is an extrusion device including an extrusion tip 122A for applying the thickened epoxy. The applicators 120, 122 are mounted on the frame 20 forward (relative to the direction of travel) of the press wheel 74 so that the primer and epoxy are applied to the pipe wall ahead of the ribbon 98. Both applicators 120, 122 may be mounted on motion slides 120B, 122B that utilize feedback from suitable sensors 120C, 122C such as ultrasonic sensors to ensure that the spray head 120A and extrusion tip 122A are maintained at a desired spacing from the pipe wall. Disposable material containers may be supported on the robot 10 for supplying resin to the applicators. Because the robot 10 may be applying both resins catalyzed, all wetted parts should be disposable. This is desirable for the primer system due the primer's short pot life of under an hour. The control system described above may be used to automate the application of resin for preparing the inner pipe surface in a similar way as the application of fiber is automated.

Having described the invention in detail, it will be apparent that modifications and variations are possible without departing from the scope of the invention defined in the appended claims.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A robot adapted for rotation in a pipe having a longitudinal axis and an inner surface including a circumference, the robot comprising:
a frame having an axis about which the frame is adapted to rotate in use, the axis of rotation extending in generally the same direction as the longitudinal axis of the pipe when the robot is positioned in the pipe;
a plurality of wheels connected to the frame at different radial positions with respect to the axis of rotation for engaging the inner surface of the pipe at different circumferential positions;
a drive mechanism adapted for driving at least one of the wheels for causing the wheel to roll along the inner surface of the pipe and the frame to rotate in the pipe about the longitudinal axis of the pipe;
the wheels being adapted for rolling along the inner surface of the pipe in a generally helical path for moving the frame along the longitudinal axis of the pipe as the frame rotates in the pipe.

2. A robot as set forth in claim 1 wherein at least one of the wheels is movably connected to the frame for permitting selective movement of the wheel radially with respect to the axis of rotation of the frame.

3. A robot as set forth in claim 1 further comprising a material application assembly connected to the frame, the fiber application assembly being adapted for applying material to the inner surface of the pipe in a generally helical pattern as the frame moves in the pipe.

4. A robot as set forth in claim 3 wherein the material application assembly includes a press member for pressing a web of the material against the inner surface of the pipe as the frame rotates in the pipe.

5. A robot as set forth in claim 4 wherein the material application assembly includes a drive mechanism adapted for advancing the web of material toward the press member.

6. A robot as set forth in claim 5 further comprising a material holder adapted for holding a supply of material for application by the press member to the inner surface of the pipe.

7. A robot as set forth in claim 5 further comprising a control system, the control system including a controller in operative connection with the drive mechanism and including instructions for adjusting the rate at which the drive mechanism advances the web of material toward the press member such that the material pressed by the press member against the inner surface of the pipe is in a generally non-tensioned state.

8. A robot as set forth in claim 7 wherein the control system includes a web tension sensor, the web tension sensor being adapted for sensing tension of the web of material on the material application assembly and generating a web tension signal representative of the tension of the web, the controller being operatively connected to the web tension sensor and including instructions to adjust the rate at which the drive mechanism advances the web of material toward the press member as a function of the web tension signal received from the web tension sensor.

9. A robot as set forth in claim 3 further including an adjustment mechanism adapted for adjusting an orientation of at least one of the wheels with respect to the frame to change a rate at which the frame advances along the longitudinal axis of the pipe as the frame rotates in the pipe.

10. A robot as set forth in claim 9 further comprising a control system including a controller operatively connected to the adjustment mechanism and including instructions for automatically adjusting the orientation of the wheel to cause the material application assembly to apply fiber to the inner surface of the pipe in a generally consistent helical pattern in which material applied in a revolution in the pipe is spaced generally consistently from material applied in a previous revolution.

11. A robot as set forth in claim 10 wherein the control system includes a material position sensor adapted for sensing a position of material applied to the inner surface of the pipe by the material application assembly and generating a material position signal representative of said position, the controller being operatively connected to the material tension sensor and including instructions to adjust the orientation of said wheel as a function of the material position signal received from the fiber position sensor.

12. A robot as set forth in claim 10 wherein the control system includes instructions to adjust the orientation of said wheel to achieve a generally consistent overlap of material applied to the inner surface of the pipe in successive rotations of the frame about the longitudinal axis of the pipe.

13. A robot as set forth in claim 1 further comprising a resin applicator connected to the frame, the resin applicator being adapted for applying resin to the inner surface of the pipe in a generally helical pattern as the frame rotates in the pipe.

14. A method of applying material to an inner surface of a pipe to reinforce the pipe, the method comprising:
driving a wheel against the inner surface of the pipe to cause a frame to which the wheel is connected to rotate within the pipe and move along a longitudinal axis of the pipe;
as the frame rotates within the pipe, applying material from a web of material to the inner surface of the pipe in a generally helical pattern.

15. A method as set forth in claim 14 further comprising automatically adjusting a rate at which the web of material is advanced toward the inner surface of the pipe such that the web of material is generally non-tensioned as it is applied to the inner surface of the pipe.

16. A method as set forth in claim 14 further comprising sensing a tension of the web of material before it is applied to the inner surface of the pipe and adjusting the rate at which the web of material is advanced toward the inner surface of the pipe as a function of the sensed tension.

17. A method as set forth in claim 14 further comprising automatically adjusting the rate at which the frame moves along the longitudinal axis of the pipe per revolution of the frame in the pipe to apply material to the inner surface of the pipe in a generally consistent helical pattern in which material applied in a revolution in the pipe is spaced generally consistently from material applied in a previous revolution.

18. A method of applying fiber to a structure for reinforcing the structure, the method comprising:
driving fiber toward a press member;
moving the press member with respect to the structure to apply the fiber to the structure by pressing it on the structure;
automatically adjusting a rate at which the fiber is driven toward the press member such that the fiber pressed by the press member against the structure is generally non-tensioned.
